(19) United States
(12) Patent Application Publication
(10) Pub. No.: US 2024/0372460 A1
(43) Pub. Date: Nov. 7, 2024

(54) GATE DRIVE CIRCUIT

(71) Applicant: ROHM CO., LTD., Kyoto (JP)

(72) Inventors: Daichi NAKAJIMA, Kyoto (JP); Tomohisa SHINOZAKI, Kyoto (JP)

(21) Appl. No.: 18/776,435

(22) Filed: Jul. 18, 2024

Related U.S. Application Data
(63) Continuation of application No. PCT/JP2023/001706, filed on Jan. 20, 2023.

(30) Foreign Application Priority Data
Jan. 24, 2022 (JP) 2022-008944

(51) Int. Cl. H02M 1/088

(52) U.S. Cl. CPC H02M 1/088

(57) ABSTRACT

A first switch is a P-channel metal oxide semiconductor (PMOS) transistor having a source connected to a constant voltage line. A diode is connected between a drain of the first switch and a bootstrap line. A second switch is connected between the drain of the first switch and a fixed voltage line. A comparison circuit generates a detection signal indicating a magnitude relationship between a high-side power supply voltage V_{BS}, which is a potential difference between the bootstrap line and a switching line, and a threshold voltage V_{TH}. A clamping driver complementarily drives the first switch and the second switch according to the detection signal.

### CROSS REFERENCE TO PRIOR APPLICATIONS

This application is a continuation under 35 U.S.C. § 120 of PCT/JP2023/001706, filed Jan. 20, 2023, which is incorporated herein by reference, and which claimed priority to Japanese Application No. 2022-008944, filed Jan. 24, 2022. The present application likewise claims priority under 35 U.S.C. § 119 to Japanese Application No. 2022-008944, filed Jan. 24, 2022, the entire content of which is also incorporated herein by reference.

### BACKGROUND

### 1. Technical Field

The present disclosure relates to a switching circuit.

### 2. Description of the Related Art

Switching circuits such as half-bridge circuits and full-bridge circuits are used in the field of power electronics including DC/DC converters, AC/DC converters, and inverters.

FIG. 1 is a circuit diagram of a switching circuit 100R. The switching circuit 100R includes a high-side transistor MH and a low-side transistor ML connected in series, and a gate drive circuit 200R that drives the high-side transistor MH and the low-side transistor MIL. The gate drive circuit 200R controls on and off of the high-side transistor MH and the low-side transistor ML to thereby switch a switching terminal SW between two states of a high state (input voltage V_{IN}) and a low state (ground voltage 0 V) or three states obtained by adding a high impedance state to the two states.

The gate drive circuit 200R includes a high-side driver 202, a low-side driver 204, and a diode D1. The high-side transistor MH is an N-channel transistor, and in order to turn on the high-side transistor MH, a drive voltage higher than the input voltage V_{IN} is required. A bootstrap circuit is utilized to generate a drive voltage higher than the input voltage V_{IN}. The diode D1 constitutes a bootstrap circuit together with an external bootstrap capacitor C_{B}. One end of the bootstrap capacitor C_{B} is connected to the switching terminal SW of the switching circuit 100R, and a constant voltage V_{REG} is applied to the other end of the bootstrap capacitor C_{B} via the diode D1.

When the switching terminal SW is low (i.e., 0 V), the bootstrap capacitor C_{B} is charged at the constant voltage V_{REG}. When the low-side driver 204 is set to a low output and the high-side driver 202 is set to a high output, a bootstrap voltage V_{B} is applied to the gate of the high-side transistor MH. When a voltage V_{S} of the switching terminal SW, that is, the source voltage of the high-side transistor MH increases, the bootstrap voltage V_{B} increases accordingly, so that a drive voltage larger than a threshold can be applied between the gate and the source of the high-side transistor MH.

As a switching element, a silicon (Si) MOSFET or a bipolar transistor has been conventionally used, but in recent years, a high electron mobility transistor (HEMT) using gallium nitride (GaN) has attracted attention as an alternative. The GaN-HEMT has excellent high frequency characteristics, low operation resistance, and high withstand voltage, and is expected to achieve high efficiency and miniaturization of the DC/DC converter by replacing the Si device.

In FIG. 1, when the high-side transistor MH and the low-side transistor ML are configured by GaN-HEMT, an overvoltage may be applied to the bootstrap capacitor C_{B}. This is referred to as overcharge. The reason for this will be described.

When the high-side transistor MH and the low-side transistor ML are simultaneously turned on, a through electric current flows. Therefore, in order to prevent this, a dead time in which both the high-side transistor MH and the low-side transistor ML are turned off is inserted. In some applications including the DC/DC converter, during a dead time when the switching circuit 100R transitions from a low output to a high output, a reverse current flows through the low-side transistor ML. In the case of the Si-MOSFET, the voltage V_{S} of the switching terminal SW is clamped to −Vf by the body diode of the low-side transistor ML. Thus, ignoring the voltage drop across the diode D1, the voltage applied across both ends of the bootstrap capacitor C_{B} is clamped to V_{REG}+Vf.

On the other hand, the GaN-HEMT does not have a body diode, and when a reverse current flows through the low-side transistor ML, the drain-source voltage V_{DS} becomes as large as several volts. Therefore, a voltage of V_{REG}+V_{DS} is applied across both ends of the bootstrap capacitor C_{B}, and the bootstrap capacitor C_{B} is in an overcharged state.

When the high-side driver 202 outputs high in a state where the bootstrap capacitor C_{B} is overcharged, an overvoltage is applied between the gate and the source of the high-side transistor MH, and the reliability of the element is lowered.

In order to solve this problem, it is necessary to clamp the voltage V_{BS} across both ends of the bootstrap capacitor C_{B}. For example, US 2013/0241621 A1 discloses a related art. FIG. 2 is a circuit diagram of a conventional drive circuit 200S.

Specifically, in the drive circuit 200S of US 2013/0241621 A1, a switch (PMOS transistor) SW1 is inserted in series with a rectifier element (diode) D1 for bootstrap.

Resistors R11 and R12 divide the voltage V_{B} of the bootstrap terminal with the ground voltage. Resistors R21 and R22 divide the constant voltage V_{REG} with the voltage V_{S} of the switching terminal. Divided voltages V₁ and V₂ are input to a comparator 208 via switches SW11 and SW12. The switches SW11 and SW12 are controlled to be turned on during the period in which the low-side transistor ML is on. Since V_{S}≈0 V holds true during the period in which the low-side transistor ML is on, the voltage V_{B} of the bootstrap terminal, that is, the voltage V_{BS} across both ends of the bootstrap capacitor C_{B} can be compared with the threshold based on the constant voltage V_{REG}. The output of the comparator 208 is input to the gate of the PMOS transistor SW1.

In the technology described in US 2013/0241621 A1, the voltage comparison of the comparator SW1 is performed only during the period in which the low-side transistor ML is on, and during the period in which the low-side transistor ML is off, the switches SW11 and SW12 are turned off, the input voltage of the comparator 208 is held, and the comparison result is also maintained. During the period in which the switches SW11 and SW12 are off, the input of the comparator 208 becomes high impedance and is susceptible to noise. Therefore, when noise is mixed into the input terminal of the comparator 208 during the period in which the low-side transistor ML is off, erroneous detection by the comparator 208 occurs.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a circuit diagram of a switching circuit,

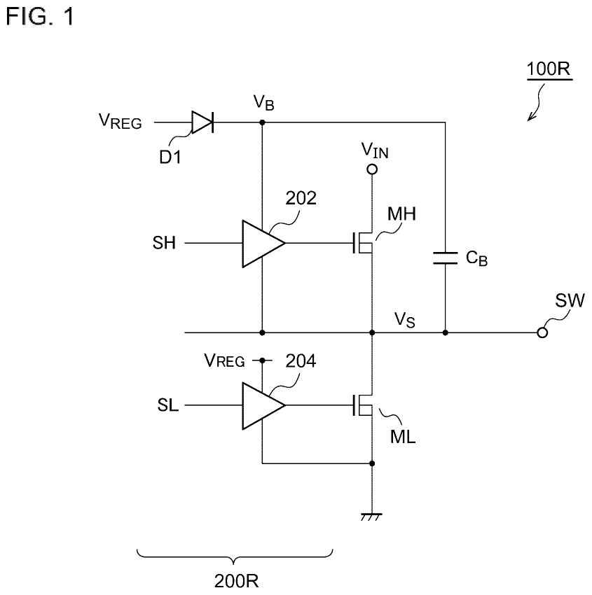

FIG. 2 is a circuit diagram of a conventional drive circuit,

FIG. 3 is a block diagram of a switching circuit including a gate drive circuit according to an embodiment,

FIG. 4A and FIG. 4B are operation waveform diagrams (simulation results) of the switching circuit of FIG. 3,

FIG. 5 is a waveform diagram (simulation result) of the voltages V_{B} and V_{S}, a high-side power supply voltage V_{BS}, an overvoltage detection signal OVDET, and a gate voltage PGATE of the switch SW1,

FIG. 6 is a circuit diagram of a switching circuit according to Comparative Technology 1,

FIG. 7 is a circuit diagram of a switching circuit according to Comparative Technology 2,

FIG. 8 is a circuit diagram illustrating a configuration example of a level shift circuit,

FIG. 9 is a circuit diagram illustrating a more specific configuration example of the level shift circuit,

FIG. 10 is a circuit diagram illustrating another configuration example of the level shift circuit;

FIG. 11 is a block diagram of a switching power supply according to the embodiment;

FIG. 12A to FIG. 12F are circuit diagrams of a power supply including a gate drive circuit; and

FIG. 13 is a circuit diagram of a switching circuit according to Modification 1.

### DETAILED DESCRIPTION

### Outline of Embodiments

An outline of some exemplary embodiments of the present disclosure will be described. This outline describes some concepts of one or more embodiments in a simplified manner for the purpose of basic understanding of the embodiments as a prelude to the detailed description that follows and does not limit the breadth of the invention or disclosure. This outline is not a comprehensive overview of all possible embodiments and is not intended to identify key elements of all embodiments or delineate the scope of some or all aspects. For convenience, “an embodiment” may be used to refer to one embodiment (example or modification) or a plurality of embodiments (examples or modifications) disclosed in the present specification.

A gate drive circuit according to an embodiment is used for a switching circuit including an N-channel high-side transistor and a low-side transistor. The gate drive circuit includes: a switching terminal to which one end of a bootstrap capacitor is to be connected, the switching terminal being connected to a source of the high-side transistor and a drain of the low-side transistor; a bootstrap terminal to which the other end of the bootstrap capacitor is to be connected; a switching line connected to the switching terminal; a bootstrap line connected to the bootstrap terminal; a high-side driver having an output connectable to a gate of the high-side transistor, an upper power supply node connected to the bootstrap line, and a lower power supply node connected to the switching line; a low-side driver having an output connectable to a gate of the low-side transistor; a first switch that is a P-channel metal oxide semiconductor (PMOS) transistor having a source connected to a constant voltage line to which a constant voltage is supplied; a rectifier element connected between a drain of the first switch and the bootstrap line; a second switch connected between the drain of the first switch and a fixed voltage line; a comparison circuit structured to generate a detection signal indicating a magnitude relationship between a high-side power supply voltage and a threshold voltage, the high-side power supply voltage being a potential difference between the bootstrap line and the switching line; and a clamping driver structured to complementarily drive the first switch and the second switch according to the detection signal.

According to this aspect, when the high-side power supply voltage exceeds the threshold, the first switch is turned off to stop charging the bootstrap capacitor, so that the high-side power supply voltage can be clamped.

Attention is paid to a voltage (referred to as an intermediate voltage) at a connection node between the first switch and the rectifier element. In this configuration, during a period in which the first switch is off, the second switch is turned on, and the intermediate voltage is fixed to the ground voltage. Therefore, it is possible to prevent the intermediate voltage from becoming a negative voltage when the voltage of the bootstrap line steeply decreases, and conversely, it is possible to suppress the intermediate voltage becoming an overvoltage when the voltage of the bootstrap line steeply increases.

In an embodiment, the second switch is an NMOS transistor having a source connected to the fixed voltage line and a drain connected to the drain of the first switch, and the clamping driver may be structured to supply a common gate signal to the first switch and the second switch.

In an embodiment, the second switch is a PMOS transistor having a drain connected to the fixed voltage line and a source connected to the drain of the first switch, and the clamping driver may supply a complementary gate signal to the first switch and the second switch.

In an embodiment, the comparison circuit may be configured to operate using the high-side power supply voltage as a power supply. The gate drive circuit may further include a level shift circuit that level-downshifts the detection signal to a signal having a low ground voltage. The clamping driver may be structured to drive the first switch and the second switch according to an output of the level shift circuit. According to this configuration, the high-side power supply voltage generated across both ends of the bootstrap capacitor can be constantly monitored by the comparison circuit regardless of whether the low-side transistor is turned on or off. Therefore, there is no period during which the input of the comparison circuit becomes high impedance, and noise resistance can be enhanced.

In an embodiment, the level shift circuit may include: a pulse generator structured to generate a set pulse and a reset pulse in response to a positive edge and a negative edge, respectively, of the detection signal, the set pulse and the reset pulse having a predetermined pulse width; an open drain circuit including a first transistor that has a source connected to the bootstrap line and is turned on in response to the set pulse, and a second transistor that has a source connected to the bootstrap line and is turned on in response to the reset pulse; and a latch circuit that includes a first transistor and second a transistor that are cross-coupled, and is structured to perform a state transition in response to an output of the open drain circuit, and the level shift circuit may be structured to output a signal according to a state of the latch circuit. According to this configuration, a high-side detection signal can be transmitted to the low-side with a low delay.

In an embodiment, the level shift circuit may further include a latch stabilization circuit that is provided between a power supply line and a ground line and is structured to fix one of complementary first node and second node of the latch circuit to low depending on an output of the level shift circuit. Acting on the first node and the second node according to the output of the level shift circuit by the latch stabilization circuit can fix the state of the latch circuit. Since the latch stabilization circuit does not need to transition the state of the latch circuit, the operation current is very small. In addition, the latch stabilization circuit is provided between a high-side line and the switching line, and the potential difference between the high-side line and the switching line is about 5 V or 12 V. Therefore, in order to fix the state of the latch circuit, power consumption can be greatly reduced as compared with a case where a current flows between the high-side line and the ground line in which the potential difference is several hundred V.

In an embodiment, the gate drive circuit may be integrated as a single unit on one semiconductor substrate. The term “integrate as a single unit” includes a case where all components of a circuit are formed on a semiconductor substrate and a case where main components of the circuit are integrated as a single unit, and some resistors, capacitors, and the like may be provided outside the semiconductor substrate for adjusting a circuit constant. By integrating the circuit on one chip, the circuit area can be reduced, and the characteristics of the circuit elements can be kept uniform.

The switching circuit according to an embodiment includes: a high-side transistor; a low-side transistor; a switching line connected to a source of the high-side transistor and a drain of the low-side transistor; a bootstrap line; a bootstrap capacitor connected between the bootstrap line and the switching line; a high-side driver having an output connectable to a gate of the high-side transistor, an upper power supply node connected to the bootstrap line, and a lower power supply node connected to the switching line; a low-side driver having an output connectable to a gate of the low-side transistor; a constant voltage line to which a constant voltage is supplied; a first switch that is a P-channel metal oxide semiconductor (PMOS) transistor having a source connected to the constant voltage line; a rectifier element connected between a drain of the first switch and the bootstrap line; a second switch connected between the drain of the first switch and a ground line; a comparison circuit structured to operate using a high-side power supply voltage as a power supply, the high-side power supply voltage being a potential difference between the bootstrap line and the switching line, and structured to generate a detection signal indicating a magnitude relationship between the high-side power supply voltage and a threshold voltage; a level shift circuit structured to level-downshift the detection signal having a low ground voltage; and a clamping driver structured to complementarily drive the first switch and the second switch according to an output of the level shift circuit.

### Embodiment

Hereinafter, a preferred embodiment will be described with reference to the drawings. The same or equivalent constituent elements, members, and processes illustrated in the drawings are denoted by the same reference numerals, and redundant description will be omitted as appropriate. Furthermore, the embodiment is not intended to limit the disclosure and the invention, but is merely an example, and all features described in the embodiment and combinations thereof are not necessarily essential to the disclosure and the invention.

In the present specification, “a state in which a member A is connected to a member B” includes not only a case where the member A and the member B are physically and directly connected to each other, but also a case where the member A and the member B are indirectly connected to each other via another member which does not substantially affect their electrical connection state or which does not impair a function or an effect exhibited by their coupling.

Similarly, “a state in which a member C is connected (provided) between the member A and the member B” includes not only a case where the member A and the member C, or the member B and the member C are directly connected to each other, but also a case where the members are indirectly connected to each other via another member which does not substantially affect their electrical connection state or which does not impair a function or an effect exhibited by their coupling.

In addition, in the present specification, a sign attached to an electric signal such as a voltage signal and a current signal, or a circuit element such as a resistor, a capacitor, or an inductor represents a voltage value, a current value, or a circuit constant (resistance value, capacitance value, inductance) as necessary.

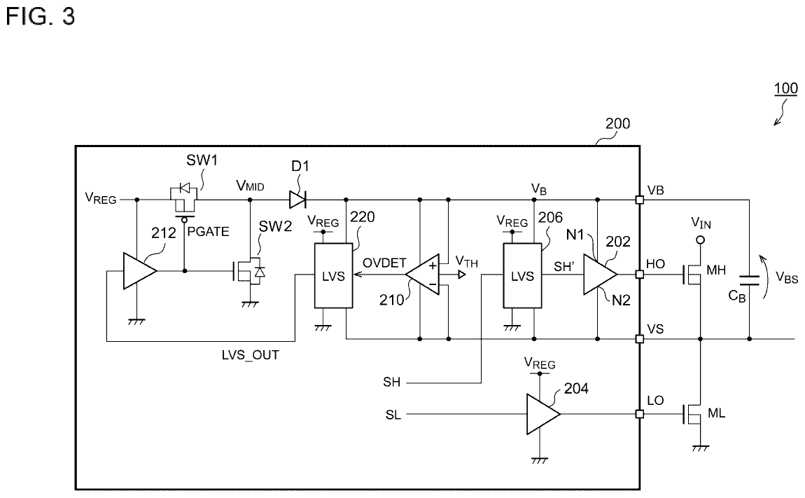

FIG. 3 is a block diagram of a switching circuit 100 including a gate drive circuit 200 according to an embodiment. The switching circuit 100 includes a high-side transistor MH, a low-side transistor ML, a bootstrap capacitor C_{B}, and the gate drive circuit 200. The high-side transistor MH and the low-side transistor ML are GaN-HEMTs (GaN-FETs).

The gate drive circuit 200 controls the high-side transistor MH and the low-side transistor ML. The gate drive circuit 200 turns on the high-side transistor MH when a high-side pulse SH is high and turns off the high-side transistor MH when the high-side pulse SH is low. In addition, the gate drive circuit 200 turns on the low-side transistor ML when a control signal SL is high and turns off the low-side transistor ML when the control signal SL is low.

The gate drive circuit 200 includes a high-side driver 202, a low-side driver 204, a level shifter 206, a diode (rectifier element) D1, a first switch SW1, a second switch SW2, a comparison circuit 210, a level shift circuit 220, and a clamping driver 212, and is integrated on one semiconductor substrate.

An output pin HO of the gate drive circuit 200 is connected to the gate of the high-side transistor MH, and a switching pin (terminal) VS is connected to the source of the high-side transistor MH and the drain of the low-side transistor ML. An output pin LO of the gate drive circuit 200 is connected to the gate of the low-side transistor ML.

The low-side driver 204 drives the low-side transistor ML based on the low-side pulse SL. Specifically, the low-side driver 204 applies a high voltage V_{REG} to the gate of the low-side transistor ML when the low-side pulse SL is high and applies a low voltage (0 V) to the gate of the low-side transistor ML when the low-side pulse SL is low.

One end of the bootstrap capacitor C_{B} is connected to the VS pin, and the other end thereof is connected to a V_{B} pin. Wiring connected to the VS pin is referred to as a switching line VS. Similarly, wiring connected to the V_{B} pin is referred to as a bootstrap line V_{B}.

The level shifter 206 shifts the level of the high-side pulse SH and supplies the high-side pulse SH to the high-side driver 202. The high-side driver 202 has an output connectable to the gate of the high-side transistor MH, an upper power supply node N1 connected to the bootstrap line V_{B}, and a lower power supply node N2 connected to the switching line VS. The high-side driver 202 operates using a potential difference V_{BS}=V_{B}−V_{S} between the bootstrap pin V_{B} and the switching pin VS, that is, a voltage across both ends of the bootstrap capacitor C_{B} as a power supply voltage. Therefore, V_{BS} is referred to as a high-side power supply voltage.

The high-side driver 202 drives the high-side transistor MH according to a high-side pulse SH′ after the level shift. Specifically, the high-side driver 202 applies a high voltage V_{B} to the gate of the high-side transistor MH when the high-side pulse SH is high and applies a low voltage V_{S} to the gate of the high-side transistor MH when the high-side pulse SH is low.

The switch SW1 which is a PMOS transistor and the diode D1 which is a rectifier element are provided in series between a constant voltage line (referred to as REG line) to which a constant voltage V_{REG} is supplied and the bootstrap line V_{B}.

The comparison circuit 210 operates using a potential difference V_{BS} (high-side power supply voltage) between the bootstrap line V_{B} and the switching line VS as a power supply. The comparison circuit 210 compares the high-side power supply voltage V_{BS} with a threshold voltage V_{TH} defining a target voltage V_{BS (REF)} thereof and generates an overvoltage detection signal OVDET indicating a magnitude relationship therebetween. The detection signal OVDET becomes high in an overvoltage state of V_{BS}>V_{TH} and becomes low when satisfying V_{BS}<V_{TH}. The comparison circuit 210 can be configured using a voltage comparator.

The level shift circuit 220 level-downshifts the detection signal OVDET to a signal LVS_OUT having a low ground voltage.

The second switch SW2 is connected between the drain of the first switch SW1 (anode of the diode D1) and the ground line. In this example, the second switch SW2 is an NMOS transistor.

The clamping driver 212 is a buffer and drives the first switch SW1 and the second switch SW2 complementarily according to the output LVS_OUT of the level shift circuit 220. The clamping driver 212 supplies a common gate signal PGATE to the gates of the first switch SW1 and the second switch SW2.

The first switch SW1 is turned off when the overvoltage detection signal OVDET is high (V_{BS}>V_{TH}) and turned on when the overvoltage detection signal OVDET is low (V_{BS}<V_{TH}). On the other hand, the second switch SW2 is turned on when the overvoltage detection signal OVDET is high (V_{BS}>V_{TH}) and turned off when the overvoltage detection signal OVDET is low (V_{BS}<V_{TH}). The first switch SW1 and the second switch SW2 are controlled asynchronously with the switching of the high-side transistor MH and the low-side transistor ML.

The configurations of the gate drive circuit 200 and the switching circuit 100 have been described above. Next, the operation thereof will be described.

With the gate drive circuit 200 according to the embodiment, when the high-side power supply voltage V_{BS} exceeds the threshold value V_{TH}, the first switch SW1 is turned off, and the charging to the bootstrap capacitor C_{B} is stopped. Therefore, the high-side power supply voltage V_{BS} can be stabilized (clamped) to a voltage level determined by the threshold value V_{TH}, and the overcharge can be prevented.

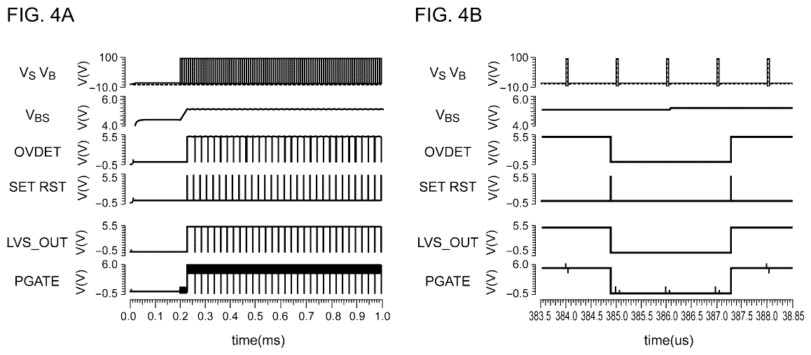

FIG. 4A and FIG. 4B are operation waveform diagrams (simulation results) of the switching circuit 100 of FIG. 3. FIG. 4B is an enlarged view of the time axis of FIG. 4A. The simulation was performed under the conditions of V_{CC}=V_{REG}=5 V, oscillation frequency 1 MHz, ON time Ton=50 ns, V_{IN}=90 V, dead time 30 ns, and C_{B}=1 μF.

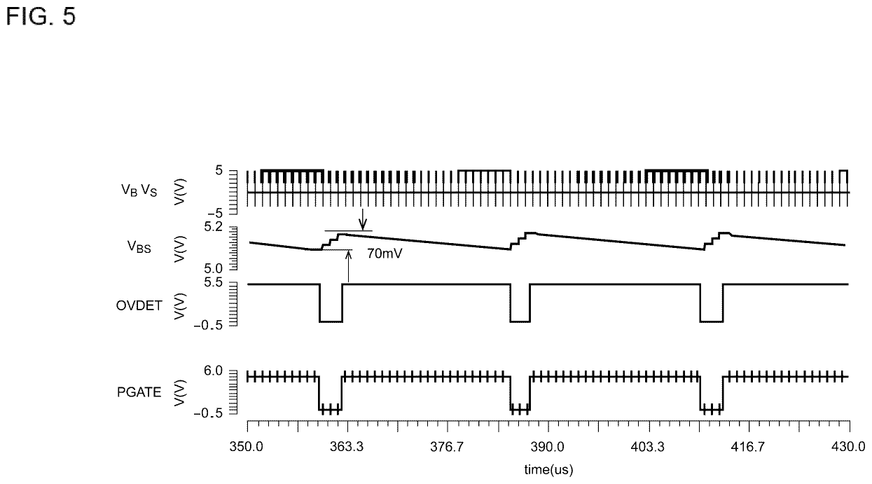

FIG. 5 is a waveform diagram (simulation result) of the voltages V_{B} and V_{S}, the high-side power supply voltage V_{BS}, the overvoltage detection signal OVDET, and the gate voltage PGATE of the switch SW1. When the high-side power supply voltage V_{BS} exceeds the threshold value V_{TH}, the overvoltage detection signal OVDET becomes high, the PGATE signal becomes high, and the switch SW1 is turned off. During this period, the high-side power supply voltage V_{BS} decreases. Then, when the high-side power supply voltage V_{BS} falls below the threshold value V_{TH}, the overvoltage detection signal OVDET becomes low, the PGATE signal becomes low, and the switch SW1 is turned on. During this period, the bootstrap circuit becomes active, and high-side power supply voltage V_{BS} rises every time the switching voltage V_{S} switches. In this example, the ripple width of the high-side power supply voltage V_{BS} is as very small as 70 mV.

The above is the operation of the switching circuit 100.

In the switching circuit 100, regardless of whether the low-side transistor ML is turned on or off, the comparison circuit 210 can constantly monitor the high-side power supply voltage V_{BS} generated across both ends of the bootstrap capacitor C_{B}. Therefore, there is no period during which the input of the comparison circuit 210 becomes high impedance, and noise resistance can be enhanced.

In the prior art, since there is a stop period of the comparison circuit 210, the ripple of the high-side power supply voltage V_{BS} increases. On the other hand, with the gate drive circuit 200 according to the embodiment, the ripple of the high-side power supply voltage V_{BS} can be reduced.

Further advantages of the switching circuit 100 will be clarified by comparison with comparative technologies.

### Comparative Technology 1

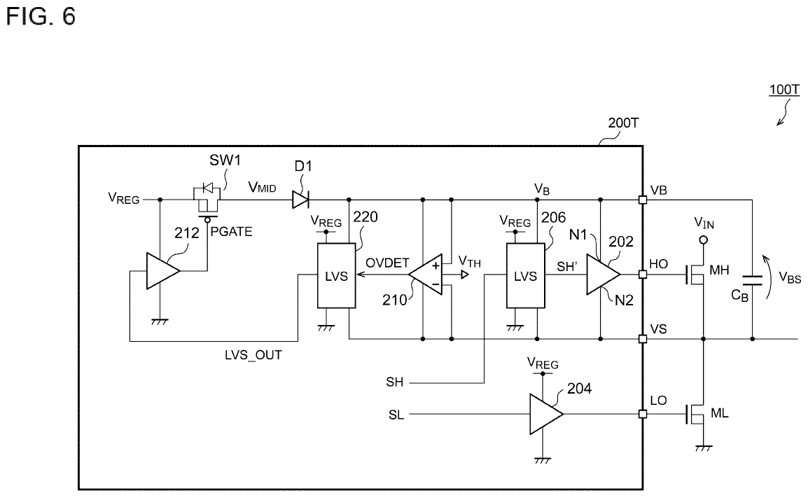

FIG. 6 is a circuit diagram of a switching circuit 100T according to Comparative Technology 1. A gate drive circuit 200T of the switching circuit 100T is obtained by omitting the second switch SW2 from the gate drive circuit 200 of FIG. 3.

Attention is paid to a voltage (referred to as an intermediate voltage V_{MID}) of a connection node between the first switch SW1 and the diode D1. During a period in which the first switch SW1 is on, that is, when the clamping operation is not applied, the intermediate voltage V_{MID} is equal to the constant voltage V_{REG}.

On the other hand, during the period in which the first switch SW1 is off, that is, when the clamping operation is applied, the drain of the first switch SW1 (the anode of the diode D1) has high impedance. The voltage V_{B} of the bootstrap line V_{B} takes a high state (≈V_{IN}) and a low state (≈0 V) in synchronization with the switching of the switching circuit 100T. The diode D1 has a parasitic capacitance. When the bootstrap line V_{B} transitions from high to low, a voltage component swinging in the negative direction passes through the parasitic capacitance and is input to a high-impedance node, and the intermediate voltage V_{MID} greatly swings in the negative direction. A large negative intermediate voltage V_{MID} is not preferable because an overvoltage may be applied to the first switch SW1.

### Comparative Technology 2

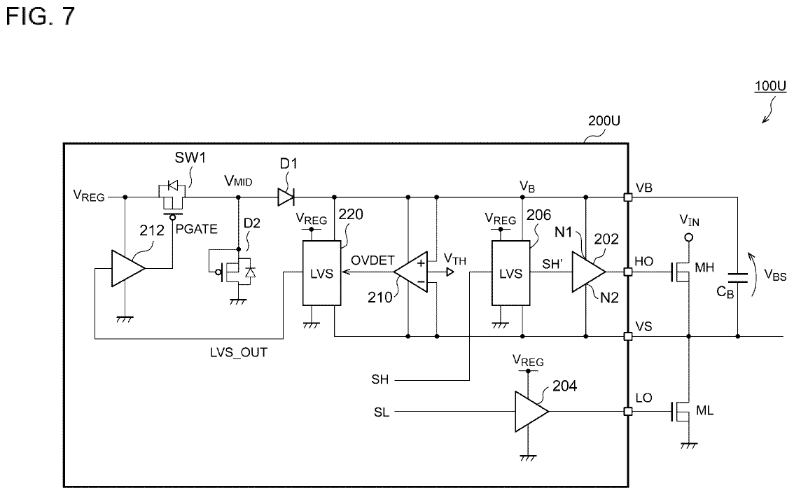

FIG. 7 is a circuit diagram of a switching circuit 100U according to Comparative Technology 2. A gate drive circuit 200U is obtained by adding a diode D2 to the gate drive circuit 200T of FIG. 6. The diode D2 is a PMOS transistor having the gate and the source connected to each other.

Similarly to Comparative Technology 1, attention is paid to the voltage (referred to as intermediate voltage V_{MID}) of the connection node between the first switch SW1 and the diode D1. In Comparative Technology 2, the intermediate voltage V_{MID} is clamped by the diode D2 so as not to be lower than −Vf. Therefore, even when the bootstrap line V_{B} transitions from high to low, it is possible to prevent the intermediate voltage V_{MID} from greatly swinging in the negative direction.

On the other hand, in Comparative Technology 2, when the bootstrap line V_{B} transitions from low to high, a voltage component swinging in the positive direction passes through the parasitic capacitance of the diode D1, and the intermediate voltage V_{MID} greatly swings in the positive direction. Then, the voltage across both ends of the diode D2 becomes an overvoltage, which may adversely affect the reliability of the diode D2.

Returning to FIG. 3, advantages of the switching circuit 100 of FIG. 3 with respect to Comparative Technologies 1 and 2 will be described.

In the configuration of FIG. 3, during the clamp period in which the first switch SW1 is off, the second switch SW2 is on, and the intermediate voltage V_{MID} is fixed to the ground voltage. Therefore, in both a case where the voltage V_{B} of the bootstrap line V_{B} steeply decreases and a case where the voltage V_{B} of the bootstrap line V_{B} steeply increases, the intermediate voltage V_{MID} is kept around the ground voltage, so that it is possible to prevent positive overvoltage and negative overvoltage.

Next, a more specific configuration example of the gate drive circuit 200 will be described.

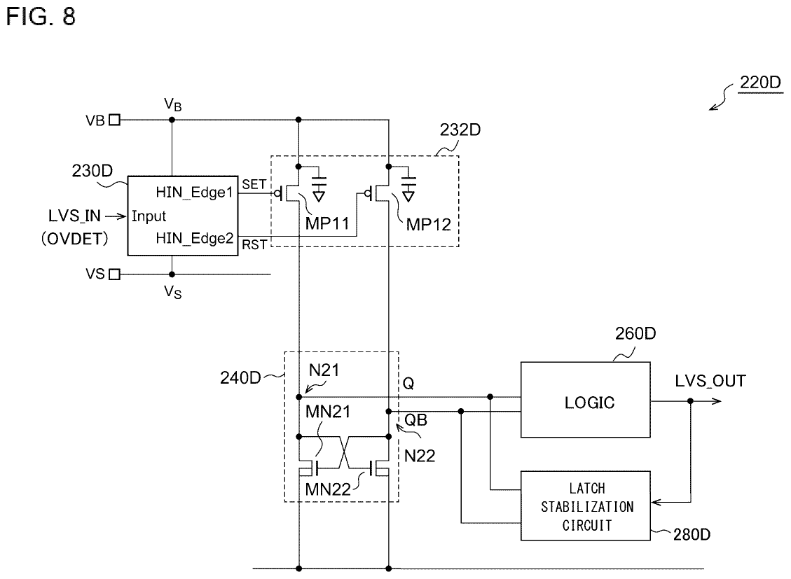

FIG. 8 is a circuit diagram illustrating a configuration example of a level shift circuit 220D. The level shift circuit 220D is a level shift down circuit that converts an input signal LVS_IN (the above-described detection signal OVDET) in which V_{B} is high and V_{S} is low into an output signal LVS_OUT (LVS_OUT) in which the power supply voltage V_{CC} (or V_{REG}) is high, and the ground voltage 0 V is low.

The level shift circuit 220D includes a pulse generator 230D, an open drain circuit 232D, a latch circuit 240D, a logic circuit 260D, and a latch stabilization circuit 280D.

The pulse generator 230D is a one-shot circuit, and generates a negative logic set pulse SET and a reset pulse RST that are low for a period of a predetermined pulse width in response to a positive edge and a negative edge of the input signal LVS_IN.

The open drain circuit 232D includes PMOS transistors MP11 and MP12. The source of the first transistor MP11 is connected to the bootstrap line V_{B} and is turned on in response to the set pulse SET. The source of the second transistor MP12 is connected to the bootstrap line V_{B} and is turned on in response to the reset pulse RST.

The latch circuit 240D includes PMOS transistors MP21 and MP22. The first transistor MP21 and the second transistor MP22 are cross-coupled and perform state transition in response to the output of the open drain circuit 232D.

The latch stabilization circuit 280D fixes one of complementary first node N21 and second node N22 of the latch circuit 240D depending on the output LVS_OUT of the level shift circuit 220D to high.

The logic circuit 260D receives an output (at least one of voltages of the first node N21 and the second node N22) of the latch circuit 240D and generates a level shift output signal LVS_OUT.

The latch stabilization circuit 280D is configured to maintain a low of one of the complementary first node N21 and second node N22 of the latch circuit 240D depending on the level (high, low) of the output LVS_OUT of the level shift circuit 220.

For example, the latch stabilization circuit 280D operates to maintain a high of the first node N21 when LVS_OUT is high, that is, the first node N21 is high, and operates to maintain a high of the second node N22 when LVS_OUT is low, that is, the second node N22 is high.

Alternatively, the latch stabilization circuit 280D may be configured to operate to maintain a low of the second node N22 when LVS_OUT is high, that is, the first node N21 is high, and to maintain a low of the first node N21 when LVS_OUT is low, that is, the second node N22 is high.

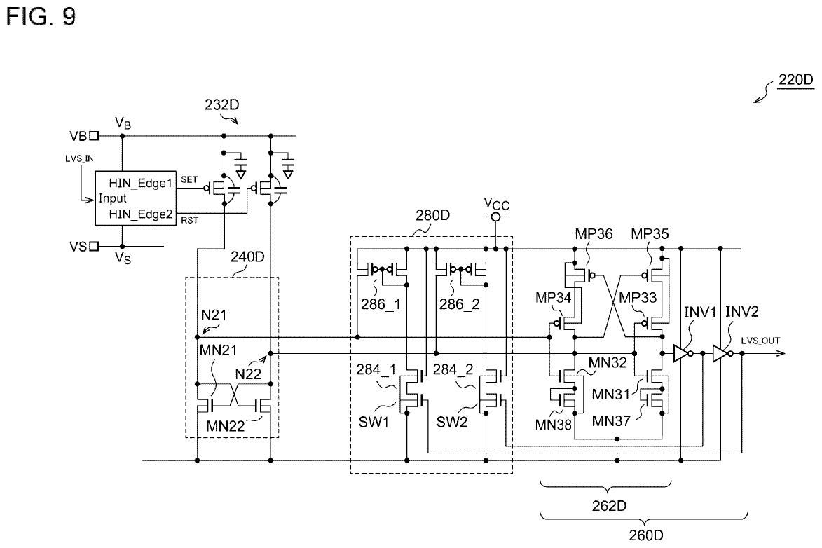

FIG. 9 is a circuit diagram illustrating a more specific configuration example of the level shift circuit 220D. The logic circuit 260D includes a level shifter-cum-latch circuit 262D and inverters INV1 and INV2.

The level shifter-cum-latch circuit 262D receives and latches the output of the latch circuit 240D. The level shifter-cum-latch circuit 262D level-downshifts the output of the latch circuit 240D to a signal for setting the voltage V_{CC} to a high level and the voltage 0 V to a low level. The level shifter-cum-latch circuit 262D includes transistors MN31, MN32, and MP33 to MP38. The output of the level shifter-cum-latch circuit 262D is output via the two-stage inverters INV1 and INV2.

The latch stabilization circuit 280D includes the first switch SW1, the second switch SW2, a first impedance element 284_1, a second impedance element 284_2, a first current mirror circuit 286_1, and a second current mirror circuit 286_2. The first switch SW1 is turned on when the output LVS_OUT of the level shift circuit 220D is at the first level (high). The first impedance element 284_1 is connected in series with the first switch SW1. The first current mirror circuit 286_1 copies the current flowing through the first impedance element 284_1 and sources a current IAUX_SET to the first node N21. As a result, the node N21 is pulled up.

The second switch SW2 is turned on when the output LVS_OUT of the level shift circuit 220D is at the second level (low). The second impedance element 284_2 is connected in series with the second switch SW2. The second current mirror circuit 286_2 copies the current flowing through the second impedance element 284_2 and sources the current IAUX_RST to the second node N22. As a result, the node N22 is pulled up.

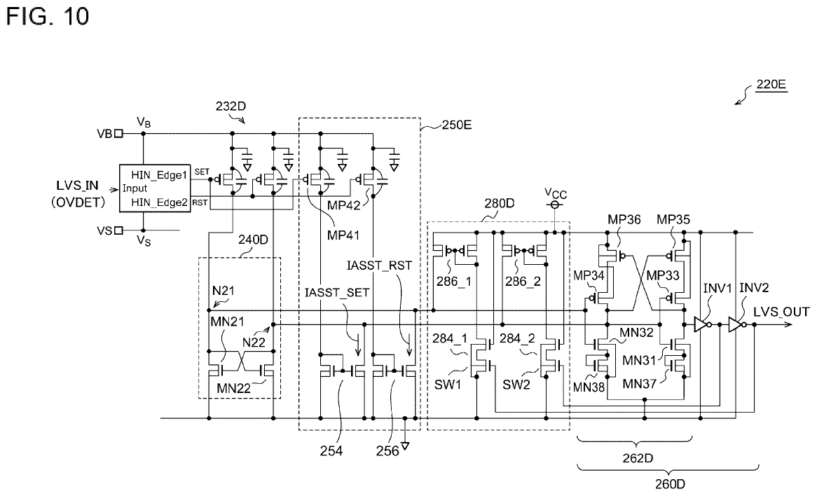

FIG. 10 is a circuit diagram illustrating another configuration example (220E) of the level shift circuit 220D. The level shift circuit 220E of FIG. 10 includes an assist circuit 250E in addition to the level shift circuit 220D of FIG. 9. The assist circuit 250E sinks an assist current IASST_SET from the second node N22 in response to the set pulse SET and sinks an assist current IASST_RST from the first node N21 in response to the reset pulse RST. For example, the level shift circuit 220E includes current mirror circuits 254 and 256. The current mirror circuit 254 copies and turns the current flowing through a transistor MP41 to generate the assist current IASST_SET. The current mirror circuit 256 copies and turns the current flowing through a transistor MP42 to generate the assist current IASST_RST. By adding the assist circuit 250E, it is possible to further increase the speed.

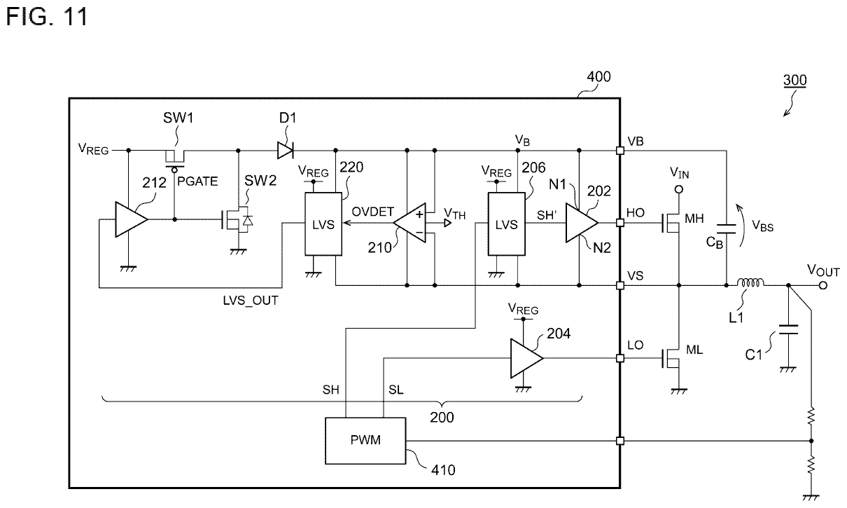

Next, applications of the switching circuit 100 and the drive circuit 200 will be described. The gate drive circuit 200 can be used as an isolated power supply or a non-isolated power supply. FIG. 11 is a block diagram of a switching power supply according to the embodiment. A switching power supply 300 is a buck converter, and includes the high-side transistor MH, the low-side transistor ML, an inductor L1, an output capacitor Cl, and a control circuit 400. The control circuit 400 includes a feedback circuit 410 in addition to the gate drive circuit 200 described above. The feedback circuit 410 receives a feedback signal V_{FB} based on an output signal (output voltage V_{OUT} or output current I_{OUT}) of the switching power supply 300 and generates pulse signals SH and SL whose duty ratio and frequency change so that the feedback signal V_{F}B approaches a predetermined target value. The feedback circuit 410 can include a pulse width modulator, a pulse frequency modulator, and the like, and can be configured by an analog circuit (error amplifier) or a digital circuit (compensator).

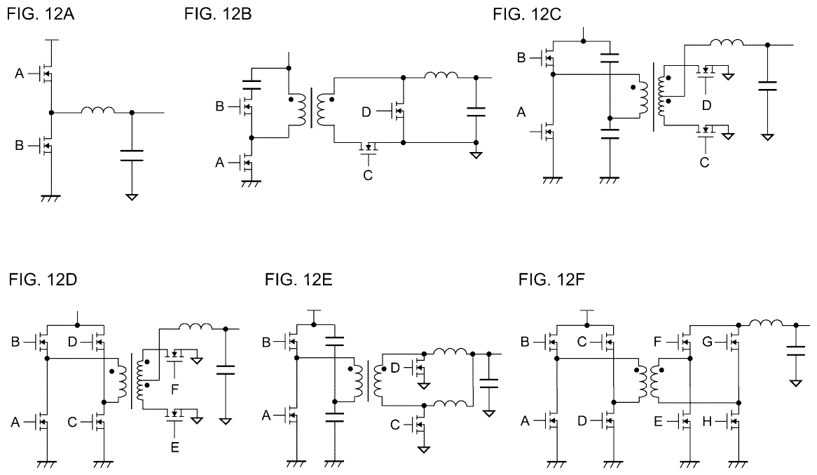

FIG. 12A to FIG. 12F are circuit diagrams of a power supply including the gate drive circuit 200. The gate drive circuit 200 can be applied to drive a pair of transistors A and B of a buck converter illustrated in FIG. 12A.

The gate drive circuit 200 is also applicable to a forward converter illustrated in FIG. 12B. Specifically, the gate drive circuit 200 can be used to drive a pair of a high-side transistor B and a low-side transistor A on the primary side.

The gate drive circuit 200 is also applicable to a half-bridge converter illustrated in FIG. 12C. Specifically, the gate drive circuit 200 can be used to drive a pair of the high-side transistor B and the low-side transistor A on the primary side.

The gate drive circuit 200 is also applicable to a full-bridge converter illustrated in FIG. 12D. Specifically, the gate drive circuit 200 can be used for a pair of the high-side transistor B and the low-side transistor A on the primary side and a pair of a high-side transistor D and a low-side transistor C on the primary side.

The gate drive circuit 200 is also applicable to a current doubler synchronous rectifier illustrated in FIG. 12E. Specifically, the gate drive circuit 200 can be used to drive a pair of the high-side transistor B and the low-side transistor A on the primary side.

The gate drive circuit 200 is also applicable to a secondary-side full-bridge synchronous rectifier illustrated in FIG. 12F. Specifically, the gate drive circuit 200 can be used to drive a pair of the high-side transistor B and the low-side transistor A on the primary side or a pair of a high-side transistor C and a low-side transistor D. In addition, the gate drive circuit 200 can be used to drive a pair of a high-side transistor F and a low-side transistor E on the secondary side or a pair of a high-side transistor G and a low-side transistor H.

The embodiment described above is intended to be illustrative only, and it will be understood by those skilled in the art that various modifications can be made to combinations of their components and processing processes. Hereinafter, such modifications will be described.

### Modification 1

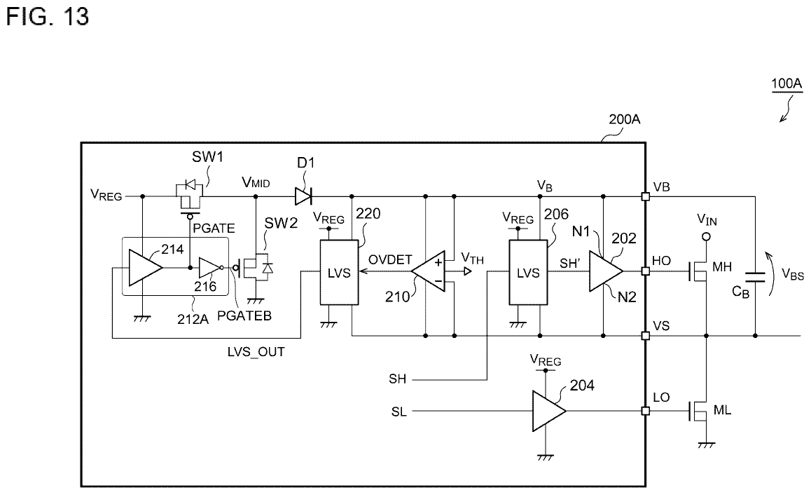

FIG. 13 is a circuit diagram of a switching circuit 100A according to Modification 1. In a gate drive circuit 200A, the second switch SW2 includes a PMOS transistor. A clamping driver 212A supplies complementary gate signals to the first switch SW1 and the second switch SW2. The clamping driver 212A includes a buffer 214 and an inverter 216. The buffer 214 generates a PGATE signal according to the output LVS_OUT of the level shift circuit 220. The inverter 216 inverts the PGATE signal and supplies the signal to the gate of the second switch SW2.

### Modification 2

In the embodiment, the diode D1 is used as the rectifier element of the bootstrap circuit, but the diode D1 may be replaced with a synchronous rectifier diode controlled in synchronization with the low-side transistor ML.

### Modification 3

In the embodiment, one end of the second switch SW2 is connected to the ground line, but the present invention is not limited thereto, and the second switch SW2 may be connected to a fixed voltage line to which another voltage other than 0 V is supplied. In this case, the clamp level of the intermediate voltage V_{MID} can be determined according to the voltage level of the fixed voltage line.

### Modification 4

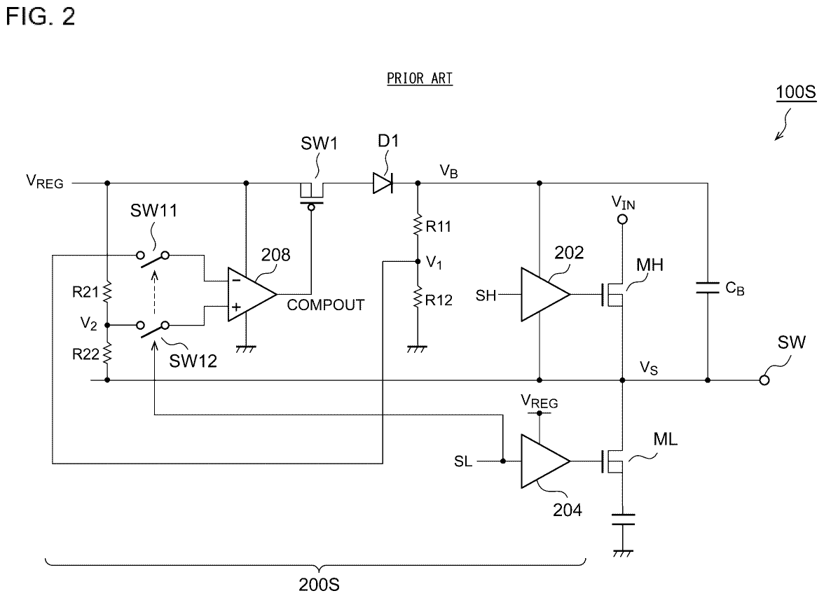

In the embodiment, the comparison circuit 210 is configured to operate using the high-side power supply voltage V_{BS} as a power supply voltage, and the detection signal OVDET is level-shifted by the level shift circuit 220 and input to the clamping driver 212, but the present invention is not limited thereto. In an application in which the influence of noise does not cause a problem, the comparison circuit 210 may be replaced with the comparator 208 illustrated in FIG. 2.

### Modification 5

The switching circuit is used in various applications such as a motor drive circuit in addition to a power supply, and the present disclosure is also applicable to applications other than the power supply.

The embodiment is intended to be illustrative only, and it will be understood by those skilled in the art that various modifications exist in combinations of their components and processing processes and that such modifications are also included in the scope of the present disclosure.

### Appendix

The technology disclosed in the present specification can be defined as follows in one aspect.

### Item 1

Agate drive circuit of a switching circuit including a high-side transistor and a low-side transistor of N channel, the gate drive circuit including:
a switching terminal to which one end of a bootstrap capacitor is to be connected, the switching terminal being connected to a source of the high-side transistor and a drain of the low-side transistor;
a bootstrap terminal to which the other end of the bootstrap capacitor is to be connected;
a switching line connected to the switching terminal;
a bootstrap line connected to the bootstrap terminal;
a high-side driver having an output connectable to a gate of the high-side transistor, an upper power supply node connected to the bootstrap line, and a lower power supply node connected to the switching line;
a low-side driver having an output connectable to a gate of the low-side transistor;
a first switch that is a P-channel metal oxide semiconductor (PMOS) transistor having a source connected to a constant voltage line to which a constant voltage is supplied;
a rectifier element connected between a drain of the first switch and the bootstrap line;
a second switch connected between the drain of the first switch and a fixed voltage line;
a comparison circuit structured to generate a detection signal indicating a magnitude relationship between a high-side power supply voltage and a threshold voltage, the high-side power supply voltage being a potential difference between the bootstrap line and the switching line; and
a clamping driver structured to complementarily drive the first switch and the second switch according to the detection signal.

### Item 2

The gate drive circuit according to Item 1, in which the second switch is an NMOS transistor having a source connected to the fixed voltage line and a drain connected to the drain of the first switch, and the clamping driver is structured to supply a common gate signal to the first switch and the second switch.

### Item 3

The gate drive circuit according to Item 1, in which the second switch is a PMOS transistor having a drain connected to the fixed voltage line and a source connected to the drain of the first switch, and the clamping driver is structured to supply a complementary gate signal to the first switch and the second switch.

### Item 4

The gate drive circuit according to any one of Items 1 to 3, in which the comparison circuit is configured to operate using the high-side power supply voltage as a power supply,
a level shift circuit structured to level-downshift the detection signal to a signal having a low ground voltage is further provided, and
the clamping driver is structured to drive the first switch and the second switch according to an output of the level shift circuit.

### Item 5

The gate drive circuit according to Item 4, in which the level shift circuit includes:
a pulse generator structured to generate a set pulse and a reset pulse in response to a positive edge and a negative edge, respectively, of the detection signal, the set pulse and the reset pulse having a predetermined pulse width;
an open drain circuit including a first transistor that has a source connected to the bootstrap line and is turned on in response to the set pulse, and a second transistor that has a source connected to the bootstrap line and is turned on in response to the reset pulse; and
a latch circuit that includes a first transistor and a second transistor that are cross-coupled, and is structured to perform a state transition in response to an output of the open drain circuit, and
the level shift circuit is structured to output a signal according to a state of the latch circuit.

### Item 6

The gate drive circuit according to Item 5, in which the level shift circuit further includes a latch stabilization circuit that is provided between a power supply line and a ground line and is structured to fix one of complementary first node and second node of the latch circuit to low depending on an output of the level shift circuit.

### Item 7

The gate drive circuit according to any one of Items 1 to 6, in which the rectifier element is a diode.

### Item 8

The gate drive circuit according to any one of Items 1 to 6, in which the rectifier element is a transistor structured to perform switching in synchronization with the switching circuit.

### Item 9

The gate drive circuit according to any one of Items 1 to 8, in which the fixed voltage line is a ground line.

### Item 10

The gate drive circuit according to any one of Items 1 to 9, in which the gate drive circuit is integrated as a single unit on one semiconductor substrate.

### Item 11

A control circuit for a switching power supply, the control circuit including the gate drive circuit according to any one of Items 1 to 10.

### Item 12

A switching power supply including the gate drive circuit according to any one of Items 1 to 10.

### Item 13

A switching circuit including:
a high-side transistor;
a low-side transistor;
a switching line connected to a source of the high-side transistor and a drain of the low-side transistor;
a bootstrap line;
a bootstrap capacitor connected between the bootstrap line and the switching line; a high-side driver having an output connectable to a gate of the high-side transistor, an upper power supply node connected to the bootstrap line, and a lower power supply node connected to the switching line;
a low-side driver having an output connectable to a gate of the low-side transistor;
a constant voltage line to which a constant voltage is supplied;
a first switch that is a P-channel metal oxide semiconductor (PMOS) transistor having a source connected to the constant voltage line;
a rectifier element connected between a drain of the first switch and the bootstrap line;
a second switch connected between the drain of the first switch and a fixed voltage line;
a comparison circuit structured to operate using a high-side power supply voltage as a power supply, the high-side power supply voltage being a potential difference between the bootstrap line and the switching line, and structured to generate a detection signal indicating a magnitude relationship between the high-side power supply voltage and a threshold voltage;
a level shift circuit structured to level-downshift the detection signal having a low ground voltage; and
a clamping driver structured to complementarily drive the first switch and the second switch according to an output of the level shift circuit.

What is claimed is:

1. A gate drive circuit of a switching circuit including an N-channel high-side transistor and a low-side transistor, the gate drive circuit comprising:
a switching terminal to which one end of a bootstrap capacitor is to be connected, the switching terminal being connected to a source of the high-side transistor and a drain of the low-side transistor;
a bootstrap terminal to which another end of the bootstrap capacitor is to be connected;
a switching line connected to the switching terminal;
a bootstrap line connected to the bootstrap terminal;
a high-side driver having an output connectable to a gate of the high-side transistor, an upper power supply node connected to the bootstrap line, and a lower power supply node connected to the switching line;
a low-side driver having an output connectable to a gate of the low-side transistor;
a first switch that is a P-channel metal oxide semiconductor (PMOS) transistor having a source connected to a constant voltage line to which a constant voltage is supplied;
a rectifier element connected between a drain of the first switch and the bootstrap line;
a second switch connected between the drain of the first switch and a fixed voltage line;
a comparison circuit structured to generate a detection signal indicating a magnitude relationship between a high-side power supply voltage and a threshold voltage, the high-side power supply voltage being a potential difference between the bootstrap line and the switching line; and
a clamping driver structured to complementarily drive the first switch and the second switch according to the detection signal.

2. The gate drive circuit according to claim 1, wherein
the second switch is an NMOS transistor having a source connected to the fixed voltage line and a drain connected to the drain of the first switch, and
the clamping driver is structured to supply a common gate signal to the first switch and the second switch.

3. The gate drive circuit according to claim 1, wherein
the second switch is a PMOS transistor having a drain connected to the fixed voltage line and a source connected to the drain of the first switch, and
the clamping driver is structured to supply a complementary gate signal to the first switch and the second switch.

4. The gate drive circuit according to claim 1, wherein
the comparison circuit is configured to operate using the high-side power supply voltage as a power supply,
a level shift circuit structured to level-downshift the detection signal to a signal having a low ground voltage is further provided, and
the clamping driver is structured to drive the first switch and the second switch according to an output of the level shift circuit.

5. The gate drive circuit according to claim 4, wherein
the level shift circuit includes:
a pulse generator structured to generate a set pulse and a reset pulse in response to a positive edge and a negative edge, respectively, of the detection signal, the set pulse and the reset pulse having a predetermined pulse width;
an open drain circuit including a first transistor that has a source connected to the bootstrap line and is turned on in response to the set pulse, and a second transistor that has a source connected to the bootstrap line and is turned on in response to the reset pulse; and
a latch circuit that includes a first transistor and a second transistor that are cross-coupled, and is structured to perform a state transition in response to an output of the open drain circuit, and
the level shift circuit is structured to output a signal according to a state of the latch circuit.

6. The gate drive circuit according to claim 5, wherein the level shift circuit further includes a latch stabilization circuit that is provided between a power supply line and a ground line and is structured to fix one of complementary first node and second node of the latch circuit to low depending on an output of the level shift circuit.

7. The gate drive circuit according to claim 1, wherein the rectifier element is a diode.

8. The gate drive circuit according to claim 1, wherein the rectifier element is a transistor structured to perform switching in synchronization with the switching circuit.

9. The gate drive circuit according to claim 1, wherein the fixed voltage line is a ground line.

10. The gate drive circuit according to claim 1, wherein the gate drive circuit is integrated as a single unit on one semiconductor substrate.

11. A control circuit for a switching power supply, the control circuit comprising the gate drive circuit according to claim 1.

12. A switching power supply comprising the gate drive circuit according to claim 1.

13. A switching circuit comprising:
a high-side transistor;
a low-side transistor;
a switching line connected to a source of the high-side transistor and a drain of the low-side transistor;
a bootstrap line;
a bootstrap capacitor connected between the bootstrap line and the switching line;
a high-side driver having an output connectable to a gate of the high-side transistor, an upper power supply node connected to the bootstrap line, and a lower power supply node connected to the switching line;
a low-side driver having an output connectable to a gate of the low-side transistor;
a constant voltage line to which a constant voltage is supplied;
a first switch that is a P-channel metal oxide semiconductor (PMOS) transistor having a source connected to the constant voltage line;
a rectifier element connected between a drain of the first switch and the bootstrap line;
a second switch connected between the drain of the first switch and a fixed voltage line;
a comparison circuit structured to operate using a high-side power supply voltage as a power supply, the high-side power supply voltage being a potential difference between the bootstrap line and the switching line, and structured to generate a detection signal indicating a magnitude relationship between the high-side power supply voltage and a threshold voltage;
a level shift circuit structured to level-downshift the detection signal having a low ground voltage; and
a clamping driver structured to complementarily drive the first switch and the second switch according to an output of the level shift circuit.
